(19) United States
(12) Patent Application Publication
(10) Pub. No.: US 2025/0139491 A1
(43) Pub. Date: May 1, 2025

(54) SINGLE-TARGET TRACKING METHOD BASED ON CREDIT ALLOCATION NETWORK

(71) Applicant: YANGTZE DELTA REGION INSTITUTE (HUZHOU), UNIVERSITY OF ELECTRONIC SCIENCE AND TECHNOLOGY OF CHINA, Huzhou (CN)

(72) Inventors: Huanlong Zhang, Huzhou (CN); Yanchun Zhao, Huzhou (CN); Panyun Wang, Huzhou (CN); Fengli Shen, Huzhou (CN); Fusheng Li, Huzhou (CN); Pengpeng Zhi, Huzhou (CN); Weiqiang Fu, Huzhou (CN); Xiangbo Yang, Huzhou (CN)

(21) Appl. No.: 18/383,908

(22) Filed: Oct. 26, 2023

(30) Foreign Application Priority Data
Oct. 18, 2023 (CN) 202311359381.8

(51) Int. Cl. G06N 20/00

(52) U.S. Cl. CPC G06N 20/00

(57) ABSTRACT

The present disclosure discloses a single-target tracking method based on a credit allocation network. The credit allocation network is at first provided, which can be updated online using a guiding focus loss function. The credit allocation network generates credit scores for the tracking results by learning features of the target object, which ensures that the reliable samples are updated for storage in the memory pool. In order to better adapt to the changes in the appearance of the target during the tracking process, a new memory selection strategy is provided to collect high-quality tracking results as the memory samples during the tracking process, which further improves the reliability and adaptability of the memory pool. The present disclosure uses the guiding focus loss function to update the credit allocation network online, which can select more reliable memory samples for the memory pool and improve the robustness of the tracking results.

### CROSS-REFERENCE TO RELATED APPLICATIONS

The present application claims the priority of Chinese Invention application Ser. No. 20/231,1359381.8 filed on Oct. 18, 2023, the entire contents of which are hereby incorporated by reference.

### TECHNICAL FIELD

The present disclosure relates to the technical field of target object tracking, and more particularly, to a single-target tracking method based on a credit allocation network.

### BACKGROUND

In recent years, the rapid development of deep learning technology has greatly promoted visual target tracking tasks. Visual target tracking involves estimating a location of a specific target in each frame of a video sequence, which is increasingly used in different fields such as human-computer interaction, safety monitoring and intelligent driving. However, due to complex background disturbances, it is still challenging to develop a tracker with strong adaptability and robustness.

At present, the tracking solution based on template matching is widely discussed, which usually generates a target template according to a target location in a previous frame or an initial frame for the tracking of the target in subsequent frames. However, when the target changes dramatically in the tracking process, a form of the target in the frame to be tracked may be closer to that in some historical frames than the initial frame or the previous frame. Therefore, always using the target in the initial frame or in the previous frame as a template affects the adaptability of the matching model. To solve the above problems, some researchers seek to obtain the target information from historical frames. Most of the researchers update the tracking model by obtaining the historical information of the target through different memory networks, however, in the real tracking scene, the target may be deformed, blocked, or be out of sight, etc., which results in tracking failure. Under such circumstances, updating the memory samples indiscriminatively may lead to contamination of a target appearance model due to lack of a robust renewal evaluation mechanism.

Therefore, it is necessary to develop an evaluation mechanism that can reflect the target tracking state, to prevent low-quality memory samples from affecting the reliability and adaptability of the target appearance model.

### SUMMARY

In view of the above problems, the present disclosure provides a single-target tracking method based on a credit allocation network, which introduces the credit allocation network to solve the contamination of the target appearance model caused by unreliable memory samples during the updating process of the memory samples, and meanwhile improves the quality of the memory samples by a new memory selection strategy.

The target object tracking method provided in the present disclosure includes:
step 1, generating a certain number of positive samples and a certain number of negative samples according to target location information provided in an initial frame, initializing the credit allocation network by a guiding focus loss function, and putting the initial frame into a memory pool as a first target memory sample;
step 2, extracting depth features of all memory samples in the memory pool using a pre-trained GoogleNet network, and stitching the depth features along a channel domain to obtain memory features;
step 3, reading a next frame image as the current frame to be tracked, cutting a current frame image according to the target location information in a previous frame image, and inputting the cut current frame image to the GoogleNet network to obtain current frame features;
step 4, inputting the memory features and the current frame features into a time-space memory network, and querying the target location information in the current frame using a memory frame to obtain a location information feature map;
step 5, reading the location information feature map of the current frame using a single convolution network to generate a classification, a centrality and a regression response map to predict the target location information in the current frame;
step 6, inputting the current frame image and the predicted target location information into the credit allocation network to obtain a credit score S of the prediction result of the current frame;
step 7, generating a certain number of positive samples and a certain number of negative samples using the current frame according to the credit score S, and updating the credit allocation network online by the guiding focus loss function;
step 8, updating the memory samples in the memory pool according to the credit score of the prediction result of each historical frame; and
step 9, circularly performing step 2 to step 7 until a video sequence is traversed to complete the target tracking.

In some embodiments, in step 1, the credit allocation network includes three convolution layers, two full connection layers and a secondary classification layer; the convolution layers are fixed by offline-training parameters, and the full connection layers and the secondary classification layer are initialized by 500 positive samples and 2000 negative samples.

In some embodiments, in step 1, the guiding focus loss function is expressed as:

$${L}_{G F} = \{ \begin{matrix}- {( 1 - {P}_{y} )}^{\frac{λ}{t}} log ( {P}_{y} ) , & when y = 1 \\ - {P}_{y}^{\frac{λ}{t}} log ( 1 - {P}_{y} ) , & otherwise\end{matrix}$$

wherein P_{y} is a predicted output; y=1 represents a positive sample; t is the number of iterations; λ is an initial focusing factor.

In some embodiments, in step 4, the process of obtaining the location information feature map includes:

calculating a similarity between each pixel of the memory feature f^{m} and the current frame feature f^{c} to obtain a similarity matrix ∧, wherein each element of the similarity matrix ∧ is calculated according to:

$${Λ}_{i j} = \frac{exp [ ( {f}_{i \cdot }^{m} {f}_{\cdot j}^{c} ) \div \sqrt{C} ]}{{\sum }_{∀ k} exp [ ( {f}_{k \cdot }^{m} {f}_{\cdot j}^{c} ) \div \sqrt{C} ]}$$

wherein i is an index of each pixel on a memory feature map, j is an index of each pixel on the current frame feature map, and [symbol] represents a dot product of vectors, √C is a scale factor set to prevent a corresponding value from being too large wherein C is a dimension of the feature map.

normalizing the similarity matrix ∧ by a function softmax, and multiplying the normalized similarity matrix by the memory features to adaptively read the target information stored therein, and stitching the current frame feature and a read-out feature along the channel domain to obtain the location information feature map:

$${f}^{l} = concat [ {( {f}^{m} )}^{T} \times softmax ( Λ ) , {f}^{c} ]$$

wherein (⋅)^{T} is an matrix transpose operation, and concat(., .) represents a series operation along a channel dimension.

In some embodiments, in step 8, the credit scores of the prediction results of all historical frames are divided into five ranges, and the frame with the highest credit score and greater than 0 in each range is selected as a memory sample to be put into the memory pool, and a sampling method of the memory samples is described as:

$${φ}_{i} = 1 + \frac{t - 1}{5} ( i - 1 ) + {arg max}_{0 \leq x < \frac{t - 1}{n} and x ∈ Z} ( {S}_{1 + \frac{t - 1}{n} ( i - 1 ) + x} \geq 0 )$$

wherein φᵢ is a sequence index of the memory sample in the historical frame, and iε{1,2, 3, 4, 5}.

The present disclosure further provides an electronic apparatus having a memory, a processor, and a computer program stored in the memory and capable of running in the processor, wherein, when being executed by the processor, the computer program implements the steps in the above single-target tracking method.

The present disclosure further provides a computer-readable storage medium with a computer program stored thereon, wherein, when being executed by the processor, the computer program implements the steps in the above single-target tracking method.

In the present disclosure, the tracking state is evaluated through the credit allocation network, which can provide a basis for updating the memory samples of the target and prevent the contamination of the target appearance model caused by background information in the tracking process. At the same time, the memory selection strategy provided in the present disclosure can effectively improve the adaptability and reliability of the target appearance model by selecting the most reliable samples in different ranges of the historical frames.

### BRIEF DESCRIPTION OF THE DRAWINGS

To describe the technical solutions in the embodiments of the present invention more clearly, the following briefly introduces the accompanying drawings required for describing the embodiments or the prior art. Apparently, the accompanying drawings in the following description show merely some embodiments of the present invention, and persons of ordinary skill in the art may still derive other drawings from these accompanying drawings without creative efforts.

FIG. 1 is a flow chart of a single-target tracking method based on a credit allocation network in accordance with an embodiment of the present disclosure;

FIG. 2 is a schematic diagram of an overall frame of the credit allocation network in accordance with an embodiment of the present disclosure; and

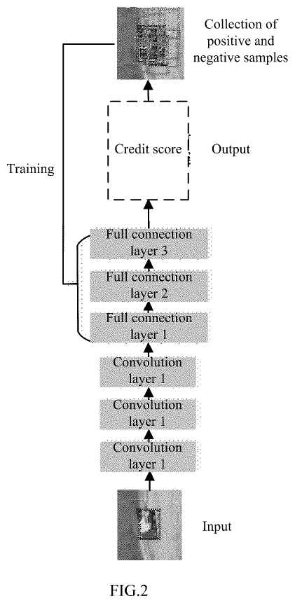

FIG. 3 is a schematic diagram showing a comparison between a tracking accuracy and a tracking success rate of the present disclosure and other algorithms on an OTB-100 data set.

### DETAILED DESCRIPTION

The technical scheme in the embodiment of the present invention will be described more directly below in combination with the drawings in the embodiment of the present invention. Obviously, the described embodiment is only a part of the embodiment of the invention, not all of the embodiment. Based on the examples in the invention, all other examples obtained by ordinary technicians in the art without creative labor fall within the scope of protection of the invention.

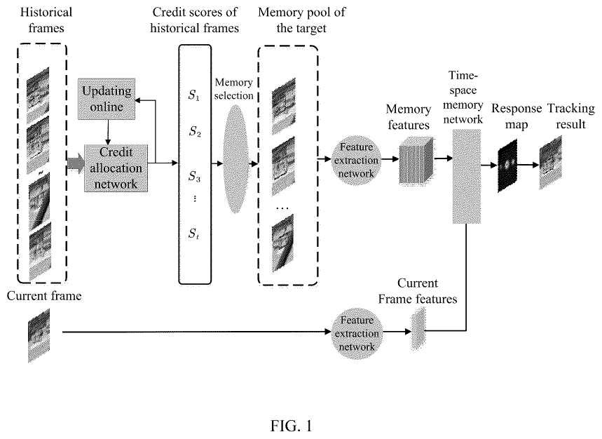

As shown in FIG. 1, a single-target tracking method based on a credit allocation network includes steps as follows.

Step 1, generating a certain number of positive samples and a certain number of negative samples according to target location information provided in an initial frame, initializing the credit allocation network by a guiding focus loss function, and putting the initial frame into a memory pool as a first target memory sample.

The credit allocation network includes three convolution layers, two full connection layers and a secondary classification layer; the convolution layers are fixed by offline-training parameters, and the full connection layers and the secondary classification layer are initialized through 500 positive samples and 2000 negative samples.

The guiding focus loss function is expressed as:

$${L}_{G F} = \{ \begin{matrix}- {( 1 - {P}_{y} )}^{\frac{λ}{t}} log ( {P}_{y} ) , & when y = 1 \\ - {P}_{y}^{\frac{λ}{t}} log ( 1 - {P}_{y} ) , & otherwise\end{matrix}$$

wherein P_{y} is a predicted output, y=1 represents a positive sample. t is the number of iterations, and λ is an initial focusing factor.

Step 2, extracting depth features of all memory samples in the memory pool using a pre-trained GoogleNet network, and stitching the depth features along a channel domain to obtain memory features.

Step 3, reading a next frame image as the current frame to be tracked, cutting a current frame image according to the target location information in a previous frame image, and inputting the cut current frame image to the GoogleNet network to obtain current frame features.

Step 4, inputting the memory features and the current frame features into a time-space memory network, and querying the target location information in the current frame using a memory frame to obtain a location information feature map.

The process of obtaining the location information feature map includes steps as follows.

Step S4.1, calculating a similarity between each pixel of the memory feature f^{m} and that of the current frame feature f^{c} to obtain a similarity matrix ∧, wherein each element of the similarity matrix ∧ calculated according to:

$${Λ}_{i j} = \frac{exp [ ( {f}_{i \cdot }^{m} {f}_{\cdot j}^{c} ) \div \sqrt{C} ]}{{\sum }_{∀ k} exp [ ( {f}_{k \cdot }^{m} {f}_{\cdot j}^{c} ) \div \sqrt{C} ]}$$

wherein i is an index of each pixel on a memory feature map, j is an index of each pixel on the current frame feature map, [symbol] and represents a dot product of vectors. A scale factor √C is set to prevent the corresponding value from being too large, wherein C is a dimension of the feature map.

Step S4.2, normalizing the similarity matrix ∧ by a function softmax, and multiplying the normalized similarity matrix by the memory features to adaptively read the target information stored therein, and stitching the current frame feature and a read-out feature along the channel domain to obtain the location information feature map:

$${f}^{l} = concat [ {( {f}^{m} )}^{T} \times softmax ( Λ ) , {f}^{c} ]$$

wherein (⋅)^{T} is an matrix transpose operation, and concat(., .) represents a series operation along a channel dimension.

Step 5, reading the location information feature map of the current frame using a single convolution network to generate a classification, a centrality and a regression response map to predict the target location information in the current frame.

Step 6, inputting the current frame image and the predicted target location information into the credit allocation network to obtain a credit score S of the prediction result of the current frame.

Step 7, generating a certain number of positive samples and a certain number of negative samples using the current frame according to the credit score S, and updating the credit allocation network online by the guiding focus loss function.

Step 8, updating the memory samples in the memory pool according to the credit score of the prediction result of each historical frame.

The memory samples can be updated by: dividing credit scores of the prediction results of all historical frames into five ranges, and selecting the frame with the highest credit score and greater than 0 in each range as a memory sample to be put into the memory pool, wherein a sampling method of the memory samples can be formally described as:

$${φ}_{i} = 1 + \frac{t - 1}{5} ( i - 1 ) + {arg max}_{0 \leq x < \frac{t - 1}{n} and x ∈ Z} ( {S}_{1 + \frac{t - 1}{n} ( i - 1 ) + x} \geq 0 )$$

wherein φᵢ is a sequence index of the memory sample in the historical frame, and iε{1,2, 3, 4, 5}

Step 9, circularly performing step 2 to step 7 until a video sequence is traversed to complete the target tracking.

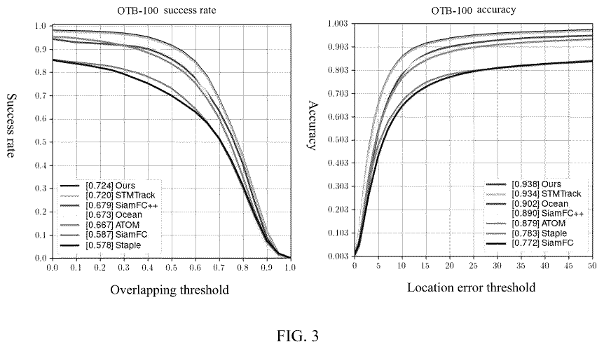

The method provided in the present disclosure is based on the implementation of Pytorch, and the experiment is carried out on a PC with a memory of 16.0 GB, a processor of Intel (R) Core (TM) i7-10700 (2.90 Hz), and a GPU of NVIDIA Geforce GTX 1660 SUPER. As shown in FIG. 3, the single-target tracking method based on a credit allocation network provided by the example of the present disclosure is compared with other tracking algorithms (STMTrack, SiamFC++, Ocean, ATOM, SiamFC, Staple) on the OTB-100 data set, and the results show that the algorithms provided by the present disclosure have good performance in success rate and accuracy.

It is understandable that the above-mentioned technical features may be used in any combination without limitation. The above descriptions are only the embodiments of the present disclosure, which do not limit the scope of the present disclosure. Any equivalent structure or equivalent process transformation made by using the content of the description and drawings of the present disclosure, or directly or indirectly applied to other related technologies in the same way, all fields are included in the scope of patent protection of the present disclosure.

What is claimed is:

1. A single-target tracking method based on a credit allocation network, comprising:
step 1, generating a certain number of positive samples and a certain number of negative samples according to target location information provided in an initial frame, initializing the credit allocation network by a guiding focus loss function, and putting the initial frame into a memory pool as a first target memory sample;
step 2, extracting depth features of all memory samples in the memory pool using a pre-trained GoogleNet network, and stitching the depth features along a channel domain to obtain memory features;
step 3, reading a next frame image as the current frame to be tracked, cutting a current frame image according to the target location information in a previous frame image, and inputting the cut current frame image to the GoogleNet network to obtain current frame features;
step 4, inputting the memory features and the current frame features into a time-space memory network, and querying the target location information in the current frame using a memory frame to obtain a location information feature map;
step 5, reading the location information feature map of the current frame using a single convolution network to generate a classification, a centrality and a regression response map to predict the target location information in the current frame;
step 6, inputting the current frame image and the predicted target location information into the credit allocation network to obtain a credit score S of the prediction result of the current frame;
step 7, generating a certain number of positive samples and a certain number of negative samples using the current frame according to the credit score S, and updating the credit allocation network online by the guiding focus loss function;
step 8, updating the memory samples in the memory pool according to the credit score of the prediction result of each historical frame; and
step 9, circularly performing step 2 to step 7 until a video sequence is traversed to complete the target tracking.

2. The single-target tracking method according to claim 1, wherein in step 1, the credit allocation network comprises three convolution layers, two full connection layers and a secondary classification layer; the convolution layers are fixed by offline-training parameters, and the full connection layers and the secondary classification layer are initialized by 500 positive samples and 2000 negative samples.

3. The single-target tracking method according to claim 1, wherein in step 1, the guiding focus loss function is expressed as:
$${L}_{G F} = \{ \begin{matrix}- {( 1 - {P}_{y} )}^{\frac{λ}{t}} log ( {P}_{y} ) , & when y = 1 \\ - {P}_{y}^{\frac{λ}{t}} log ( 1 - {P}_{y} ) , & otherwise\end{matrix}$$
wherein P_{y} is a predicted output, y=1 represents a positive sample, t is the number of iterations, and λ is an initial focusing factor.

4. The single-target tracking method according to claim 1, wherein in step 4, the process of obtaining the location information feature map comprises:
calculating a similarity between each pixel of the memory feature f^{m} and the current frame feature f^{c} to obtain a similarity matrix ∧, wherein each element of the similarity matrix ∧ is calculated according to:
$${Λ}_{i j} = \frac{exp [ ( {f}_{i \cdot }^{m} {f}_{\cdot j}^{c} ) \div \sqrt{C} ]}{{\sum }_{∀ k} exp [ ( {f}_{k \cdot }^{m} {f}_{\cdot j}^{c} ) \div \sqrt{C} ]}$$
wherein, i is an index of each pixel on a memory feature map, j is an index of each pixel on the current frame feature map, [symbol] represents a dot product of vectors, and √C is a scale factor set to prevent a corresponding value from being too large wherein C is a dimension of the feature map.
normalizing the similarity matrix ∧ by a function soft max, and multiplying the normalized similarity matrix by the memory features to adaptively read the target information stored therein, and stitching the current frame feature and a read-out feature along the channel domain to obtain the location information feature map:
$${f}^{l} = concat [ {( {f}^{m} )}^{T} \times softmax ( Λ ) , {f}^{c} ]$$
wherein (⋅)^{T} is an matrix transpose operation, and concat (., .) represents a series operation along a channel dimension.

5. The single-target tracking method according to claim 1, wherein in step 8, the credit scores of the prediction results of all historical frames are divided into five ranges, and the frame with the highest credit score and greater than 0 in each range is selected as a memory sample to be put into the memory pool, and a sampling method of the memory samples is described as:
$${φ}_{i} = 1 + \frac{t - 1}{5} ( i - 1 ) + {arg max}_{0 \leq x < \frac{t - 1}{n} and x ∈ Z} ( {S}_{1 + \frac{t - 1}{n} ( i - 1 ) + x} \geq 0 )$$
wherein φⁱ is a sequence index of the memory sample in the historical frame, and iε{1,2, 3, 4, 5}

6. An electronic apparatus having a memory, a processor, and a computer program stored in the memory and capable of running in the processor, wherein, when being executed by the processor, the computer program implements the steps of the single-target tracking method of claim 1.

7. An electronic apparatus having a memory, a processor, and a computer program stored in the memory and capable of running in the processor, wherein, when being executed by the processor, the computer program implements the steps of the single-target tracking method of claim 2.

8. An electronic apparatus having a memory, a processor, and a computer program stored in the memory and capable of running in the processor, wherein, when being executed by the processor, the computer program implements the steps of the single-target tracking method of claim 3.

9. An electronic apparatus having a memory, a processor, and a computer program stored in the memory and capable of running in the processor, wherein, when being executed by the processor, the computer program implements the steps of the single-target tracking method of claim 4.

10. An electronic apparatus having a memory, a processor, and a computer program stored in the memory and capable of running in the processor, wherein, when being executed by the processor, the computer program implements the steps of the single-target tracking method of claim 5.

11. A computer-readable storage medium with a computer program stored thereon, wherein, when being executed by the processor, the computer program implements the steps of the single-target tracking method of claim 1.

12. A computer-readable storage medium with a computer program stored thereon, wherein, when being executed by the processor, the computer program implements the steps of the single-target tracking method of claim 2.

13. A computer-readable storage medium with a computer program stored thereon, wherein, when being executed by the processor, the computer program implements the steps of the single-target tracking method of claim 3.

14. A computer-readable storage medium with a computer program stored thereon, wherein, when being executed by the processor, the computer program implements the steps of the single-target tracking method of claim 4.

15. A computer-readable storage medium with a computer program stored thereon, wherein, when being executed by the processor, the computer program implements the steps of the single-target tracking method of claim 5.
